(19) United States
(12) Patent Application Publication
(10) Pub. No.: US 2007/0124292 A1
(43) Pub. Date: May 31, 2007

(54) Autobiographical and other data collection system

(76) Inventors: Evan Kirshenbaum, Mountain View, CA (US); Henri Jacques Suermondt, Sunnyvale, CA (US); Kave Eshghi, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/583,504

(22) Filed: Oct. 19, 2006

Related U.S. Application Data
(62) Division of application No. 10/021,482, filed on Oct. 30, 2001, now abandoned.

(51) Int. Cl. G06F 17/30

(52) U.S. Cl. 707/3

(57) ABSTRACT

Surveillance technology particularly suited to continuous gathering of autobiographical data. Integrated into a portable construction are data collection mechanisms for capturing substantially all perceptual stimulus and acquirable digital data in the immediate vicinity of the system, a data integrator for correlating said autobiographical data, and memory for storing collected data. The unit comprises a programmable device for integrating all data captured into an integrated, content-retrievable format. Data editing formats are also suggested.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO AN APPENDIX

Not Applicable.

### BACKGROUND OF THE INVENTION

(1) Field of the Invention

The present invention relates generally to data acquisition and access, and, particularly to a system for real-time collection of selectively retrievable autobiographical data.

(2) Description of Related Art

In the state of the art microprocessor speed and memory capacity increase at an incredible rate—along a number of dimensions, computers get twice as powerful relative to price every eighteen months, or in other words, increase by about an order of magnitude every five years. Therefore, new uses for such powerful machines and programs need to be developed. Particularly, as computing speed and memory capacity drop in price, personal use systems become more powerful and more desirable.

One valuable use for powerful computing processes is multimedia, surveillance or personal data collection. There is known in the art individual devices which already employ microprocessors and application specific integrated circuits for recording specific types of data; e.g., video (with sound track capability) and still cameras for recording the local surroundings (including day-date imprints), pen-size digital dictation devices for sound recording, space satellite connected global positioning systems (GPS) for providing instantaneous position, movement tracking, date and time information, personal digital assistants (PDA) for downloadable note taking and other computing activities, biofeedback devices, e.g., portable cardio-vascular monitors, for medical patients and sports enthusiast, and the like.

For recording autobiographical thoughts and notes, hand-scribed diaries are more than just passe; they suffer from being subjective, time consuming, bulky, disaster-prone, and virtually useless for comprehensive data retrieval.

Current video and audio recording devices are typically used to record sight-rememberable places. Other than the option of a day-date stamp feature, personalization as well as mobility and location information is limited to local sound and user subvocalization commentaries. Audio-video recording medium management, such as editing, is tedious, and often requires specialized off-line equipment. Degradation of the commonly used magnetic tape over time is also a known problem in the state of the art. Moreover, actual continuous recording sessions are timed sporadically to meet the level of interest in the current subject, cost, and available battery life.

Data monitors, such as medical biometric recorders, have personalization and mobility capabilities, but measure only a limited number of targeted traits, in effect, providing a targeted data query response. Moreover, most medical monitors only collect data for transmission to some other processing facility. Security and privacy is not an issue.

There is a need for a system which will permit digital, active and passive, collection of all recordable information over virtually everything that transpires in the course and immediate vicinity of daily life. Note that such a full-data capable system can be adapted to a more targeted data collection such as in the business of surveillance.

### BRIEF SUMMARY OF THE INVENTION

In its basic aspect, the present invention provides a system for accessing a substantially comprehensive record of an immediate environment of a user, including: a substantially continuous record of information from a plurality of time-correlated input data streams; mechanisms for specifying a query into the record; and mechanisms for displaying a result of a query made using said mechanisms for specifying a query.

In another aspect, the present invention provides a portable device for capturing a substantially comprehensive record of an immediate environment of a user, including: a portable housing; associated with said housing, one or more data collection devices; and integrated with said housing, a time-keeping device, a data storage device, and a programmable device for correlating all data captured by the data collection devices based upon time reported by the time-keeping device and for storing so-correlated data on the storage device.

In still another aspect, the present invention provides a wearable device for querying a substantially comprehensive record of an immediate environment of a user, including: a portable housing; associated with said housing, at least one data output device, and at least one input device for specifying data queries; and integrated with said housing, a data storage device containing a data record and a programmable device for accepting queries from the at least one input device, for identifying sections of the record based on the queries, and for displaying the results of the queries on the at least one output device.

In another aspect, the present invention provides a system for data collection including: a portable housing; and interconnected within said housing, data collection means for capturing data representative of an immediate vicinity of the system, integration means for correlating said autobiographical data, and memory means for storing said autobiographical data.

In another aspect, the present invention provides a process for generating autobiographical data, the method including: providing an integrated apparatus for collecting data representative of perceptual stimuli in the immediate vicinity of a person; continuously collecting said data; in real-time, integrating said data in accordance with predetermined relational characteristics of said perceptual stimuli into a content retrievable data collection; and storing said data collection in a memory.

In another aspect, the present invention provides surveillance apparatus including: a portable housing; and integrated with said housing, a camera, an audio recorder, a GPS, a data memory, and a programmable device for integrating all data captured by said camera, audio recorder, and GPS into an integrated, content-retrievable format and for storing and retrieving data so formatted from said memory.

The foregoing summary is not intended to be an inclusive list of all the aspects, objects, advantages and features of the present invention nor should any limitation on the scope of the invention be implied therefrom. This Summary is provided in accordance with the mandate of 37 C.F.R. 1.73 and M.P.E.P. 608.01(d) merely to apprise the public, and more especially those interested in the particular art to which the invention relates, of the nature of the invention in order to be of assistance in aiding ready understanding of the patent in future searches. Other objects, features and advantages of the present invention will become apparent upon consideration of the following explanation and the accompanying drawings, in which like reference designations represent like features throughout the drawings.

### BRIEF DESCRIPTION OF THE DRAWINGS

FIG. 1 is a schematic block diagram of an autobiographical data collection system in accordance with the present invention.

FIG. 2 is an illustration of the invention as shown in FIG. 1 in operation.

FIG. 3 is a flow chart for data integration and programming in accordance with the present invention as shown in FIGS. 1 and 2.

FIG. 4 is a system block diagram representation of a data record, data collection apparatus, and output for the present invention.

FIG. 5 is a block diagram related to FIG. 4 showing annotation data operations in accordance with the present invention.

FIG. 6 is a block diagram illustrating data pattern matching operations in accordance with the present invention.

FIG. 7 is a flow chart for system operations which include event pattern input in accordance with the present invention as shown in FIG. 6.

FIG. 8 is a graphical illustration of a response process giving a list of attributes in accordance with the present invention.

FIG. 9 is a block diagram of an exemplary query into memory using pattern matching as described in accordance with FIGS. 6 and 7.

FIG. 10 is an illustration of the use of the system by deja vu query in accordance with the present invention as shown in FIG. 9.

FIG. 11 illustrates the security aspects of the present invention.

FIG. 12 is a flow chart illustrative of one embodiment of a data compression module in accordance with the present invention.

FIG. 13 is a block diagram illustrating use of a portable/wearable apparatus system embodiment of the present invention in conjunction with a data archive system.

FIG. 14 is a schematic diagram illustrating the operation of the present invention to capture a substantially comprehensive record of an immediate environment of the user.

FIG. 15 is illustrative of another embodiment of the present invention employing remote data collection devices.

The drawings referred to in this specification should be understood as not being drawn to scale except if specifically annotated.

### DETAILED DESCRIPTION OF THE INVENTION

Reference is made now in detail to a specific embodiment of the present invention, which illustrates the best mode presently contemplated for practicing the invention. Alternative embodiments are also briefly described as applicable.

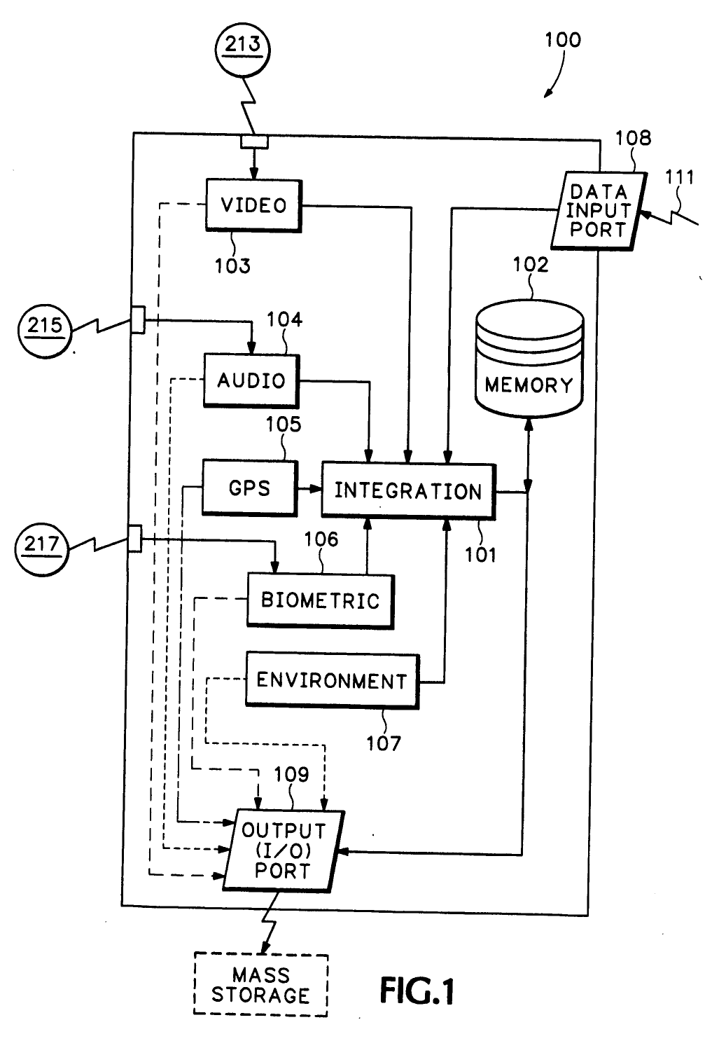

FIG. 1 is a schematic block diagram of a data collection apparatus 100 in accordance with the present invention. A central “INTEGRATION” unit, or “integrator,” 101 is a microprocessor or application specific integrated circuit (ASIC) based, programmable device, having an associated data storage unit, “MEMORY,” 102. When IC memory achieves a great enough capacity in solid state form, it can be included as part of the integrator 101. The data collection units 103-108 can be adapted from state-of-the-art products. An output port 109, wired or wireless, is provided for downloading recorded data from memory 102 to a mass data storage device or even in real-time, alternatively or in parallel, from individual data collection units 103 (indicated by phantom-line connections). In the main, the system is implemented in a motherboard fashion as would be known in the computer fabrication arts.

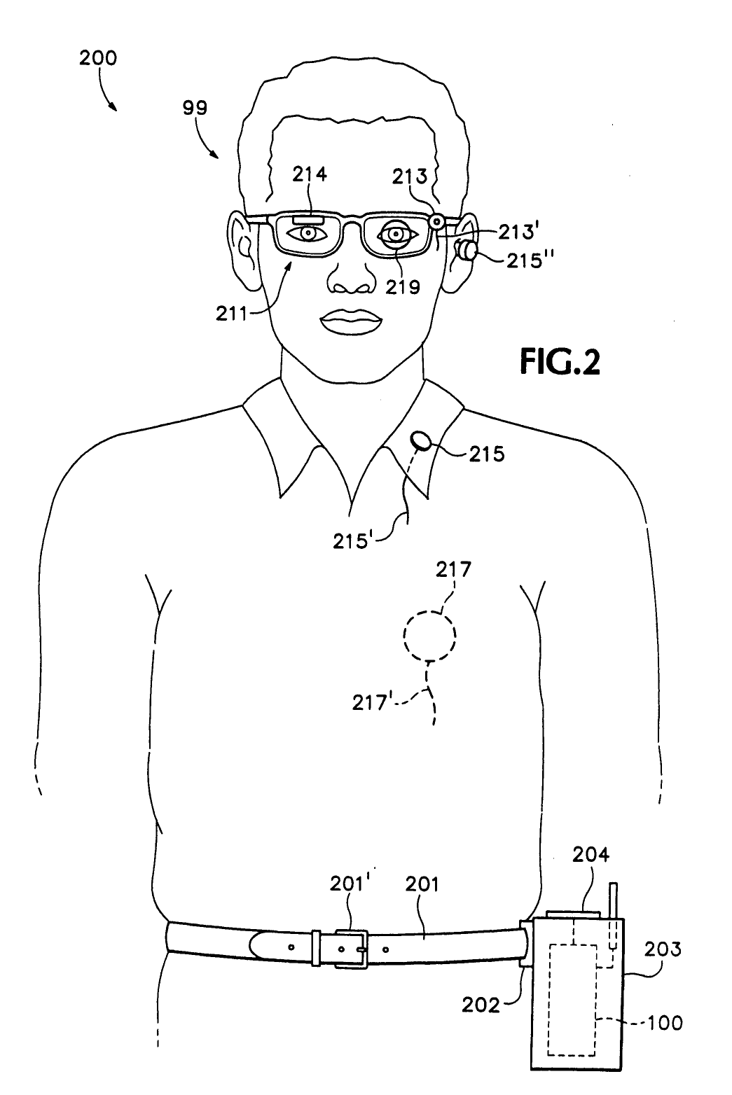

FIG. 2 illustrates a person, or “user,” 99 equiped with the present invention 100 as shown in FIG. 1 such that autobiographically related data (or surveillance data) is continuously and automatically recorded. The autobiographical data collection apparatus 100 is housed via an unobtrusive, belt 201 mount 202 and case 203; waist pack, backpack, briefcase or other convenient carrying implementations can be designed to provide equivalent carrying convenience.

A control panel 204 is implemented in any known manner, but preferably is such as a touch screen LCD display and control combination, e.g., having series of scrollable or pop-up windows providing controls over the data integrator 101, including memory 102, the various data collection units 103-107, and input-output 108, 109 functions. While an all-in-one unit can be implemented for all data capture, processing and storage, in order to provide certain advantages and to miniaturize the system, it is preferred that some remote sensors for acquiring data and having data direct transmission capability are employed as needed for each of the data collection units 103-107.

For video unit 103 input, in order to provide the user 99 point of view, a headset 211, wearable as a pair of eyeglasses, incorporates a camera 213 (either full video or selective sequential still mode or both). For example, a small video camera such as the X10 model by XCam Co. of Seattle, Wash., could be employed in accordance with the present invention. The video data processor is preferably a digital type such as would be used in a common handheld camera and is incorporated into the apparatus 100 motherboard. A known manner heads-up display 214 associated with the camera output allows the user 99 to monitor the real-time field of view of the camera 213. For a less obvious implementation, e.g., for discrete field surveillance uses, the belt buckle 201′ or other less noticeable placement can be employed.

While all components and units can be hardwired, in the preferred embodiment wireless transmission, e.g., radio frequency (RF), from the remote video sensor(s) 213, audio microphone(s) 215, and biometric sensor(s) 217 is provided, each indicated as having an antenna 213′, 215′, 217′ for data transmission in a known manner.

For the audio unit 104, a remote microphone 215 is preferably positioned adjacent the vocal chord region of the user's neck so that in addition to picking up all audio stimulus around the user 99, subvocalization recording of user input can be registered. Thus, the microphone 215 is shown as an unobtrusive collar pin style. A model EMC3 microphone by Kenwood company of Long Beach, Calif., can be employed in accordance with the present invention. Note that an earpiece 215″ associated with the microphone 215 can be optionally provided; this is particularly valuable when the employed microphone is directional and is picking up particular input toward which it is pointed in an otherwise relatively noisy surrounding environment.

GPS apparatus are commercially available; e.g., a variety of models are available from Garmin International, having places of business in Olathe, Kans., and Romsey, Hampshire, United Kingdom. An adapted, incorporated GPS unit 105 provides a continuous data stream for date, time, current location, and resettable, motion mapping.

For the biometric data unit 106, a biometric data sensor 217 is appropriately mounted directly to the user's body in accordance with the make and model. For example, a model S410 heart rate monitor by Polar CIC, Inc., Burbank, Calif., can be employed in accordance with the present invention. Note that a plurality of sensors can be used; e.g., in addition to a heart/lung/blood sensor, an electro-oculographic monitor 219 might be employed, built into the headset 211. Such biometric data units 106 are well known and can provide current data regarding the user such as heart rate, temperature, blood pressure, breathing rate, blood glucose or alcohol level, and the like.

The local environmental data unit 107 can gather information regarding temperature, barometric pressure, humidity, and the like. For example, the model 53 Series II local environmental condition sensor by Fluke company of Everett, Wash., can be employed in accordance with the present invention. Any ambient environmental condition data can be provided for with an appropriately adapted state of the art monitoring device, e.g., temperature, humidity, oxygen level, radiation level, wind speed, noise level, traffic level, or the like.

A digital data input port 108 is provided for downloading data files directly from other digital devices; e.g., computers, PDAs, test instruments, from web sites (e.g., e.mail messages on an Internet capable cell phone), and the like; such direct data is represented by communication line 111. A common serial, parallel, infrared, or the like known data port can be provided in accordance with a specific implementation design goals. Similarly, a digital data output port 109 is provided for downloading from the memory 102—e.g., for putting the current session's collected data into long term, mass storage—or from specific data collection units 103-107 via user commands using the control panel 204. While not shown, the data ports 108, 109, can include portable telephone equipment and capability.

In the current state of the art, high capacity memory drives in a one-inch diameter hard disk with associated read-write electronics have been reduced in size to where a wearable, belt-pack, data storage unit can be used to record up to 80 Gbytes of data. Such a storage device as model WD800BBRTL by Western Digital company of Lake Forest, Calif., can be adapted for use in accordance with the present invention. Magnetic tape drives such as those manufactured by Seagate Corp. of Scotts Valley, Calif., can be adapted and employed. MP3 devices such as those manufactured by Creative Labs might also be employed.

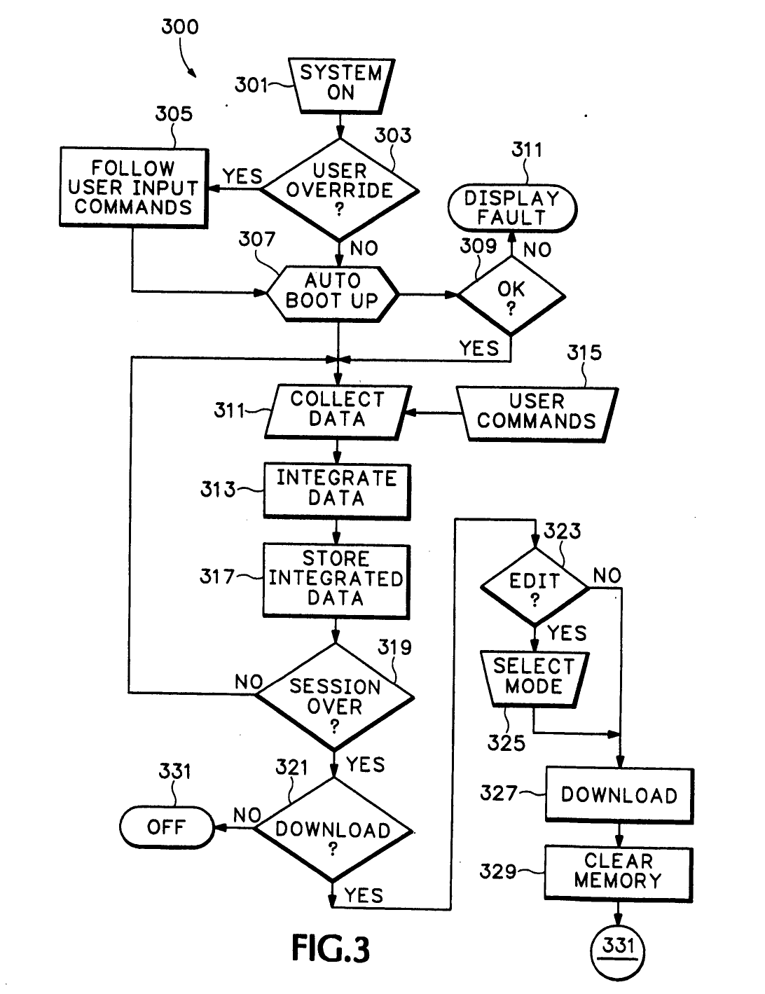

The heart of the invention is the integrator 101. The basic methodology 300, implementable via known manner firmware/software programming techniques, in accordance with the present invention is shown in the flowchart of FIG. 3. Simultaneous reference to FIGS. 1 and 2 will assist in the understanding of the following.

Assuming the apparatus 100 has been OFF, e.g., over-night, charging batteries, or the like, the first step is to turn the system ON, step 301. Having a control panel 204 indicating that the apparatus 100 is initializing, the user 99 may wish to immediately jump to some limited mode of operation, step 303, YES-path; e.g., allowing an Internet download 111 via the input port 108 while using a public access terminal. Otherwise, step 303, NO-path, or when the user has finished the specific task(s) commanded, step 305, the integrator 101 program 300 initializes all data collection units 103-107, and any associated remote sensors 211-219, automatically, step 307. Preferably, the boot-up routine includes running diagnostics, step 309, to ensure full functionality of all subunits of the apparatus 100. If the apparatus 100 is not fully functional, the display 204 reports a fault, step 311, which the user 99 must then address off-line.

Once fully booted, the system commences data collection, step 309.

Since the inputs from the data collection units 103-108 are discrete collections, data integration is provided. For example, video data and audio data inputs are synchronized and stamped with GPS information on a frame-by-frame basis. Again, illustrated by step 315, the user 99 is provided with override commands using the touch screen display 204 to customize data collection to suit the present situation; for example, turning off the GPS unit 105 while on a commercial airline where FAA regulations prohibit the use of GPS devices.

The integrated data is stored in memory 102, step 317. As the data is in effect a serial autobiography, automatically subject to every whim of the user, it is preferred that the data storage routines and memory be those used for known manner content addressable memory (CAM). The information collected will be voluminous; therefore, in the preferred embodiment, using data compression is advisable. For example, assuming the video data is the greatest user of memory, it is estimated that with data collection unit 103-107 technology currently available, a fully operational system will store about 1.5 gigabytes per hour or 24 gigabytes per 16 hour day of average use. Without integration and content addressability, data retrieval problems become nearly insurmountable.

As long as the user 99 (FIG. 2) desires, the recording session can continue, step 319, NO-path. Once the current session, or multiple recording sessions are over, if memory 102 is non-volatile (preferably) and still has sufficient empty space for a next session, step 321, NO-path, the system is simply turned OFF step 331. If necessary or desired, step 321, YES-path, the memory is downloaded to mass storage, e.g., writable CD-ROM, ZIP™ drive cartridges, or the like, steps 321, 323, 325, 327 (en masse or-edited as described hereinafter). Data storage memory 102 is reset, step 329, for a new data acquisition and storage session(s). The apparatus 100 can then be powered down, step 331.

Re-acquiring data from on-board memory 102 during a current session—e.g., via control panel 204 commands, replaying video footage on the heads-up display 214—is a valuable option, particularly useful for editing captured data. Note that other data display can be programmed; e.g., “display current electrocardiogram.”

Note that known manner or proprietary data encryption techniques can be employed to ensure the recorded data is available only to those with specific decryption capability.

With such a portable apparatus 100, an accurate, external, memory can be created of all that has gone on around the user and direct data inputs by the user (see description of elements 108/111, above). The uses of such data are legion; e.g., for surveillance operations or memories (e.g., vacation) recording, the uses are intuitively obvious; some examples of other uses follow.

The stored data can be used to replay scenes in response to queries based on time, location, object or person physical identifying features, or the like. For example, with content addressable memory, a “MATCH” command could search video records to find the identity and previous encounter with a currently displayed person or place on the heads-up display.

Another important use would be of the availability of a complete medical history from the biometric unit 106.

To continue the data rate collection example, a reasonable lifetime (75 years) of daily recording would result in about 650 terabytes of data. Therefore, as a preferred option, program routines (on-line or off-line) for selectively editing, steps 323, YES-path, and 325, the data in memory (or retrieved from an off-board mass storage bank (not shown)) is provided. Such a program can have options as simple as a time-based DELETE function for on-line editing (e.g., the last hour of recording consisted of data collected after falling asleep in a park) to advanced, video, keyframe extraction algorithms. Another option is a dynamic data degradation routine, where the full record of a session is kept on a time-based criteria or storage availability basis and then edited in a selected predetermined order, such as personal interest (e.g., “keep faces and associated data (name, occupation), delete meeting background places (office wall with hanging paintings)”; or “delete normal biometric data greater than 2 years old”; or the like).

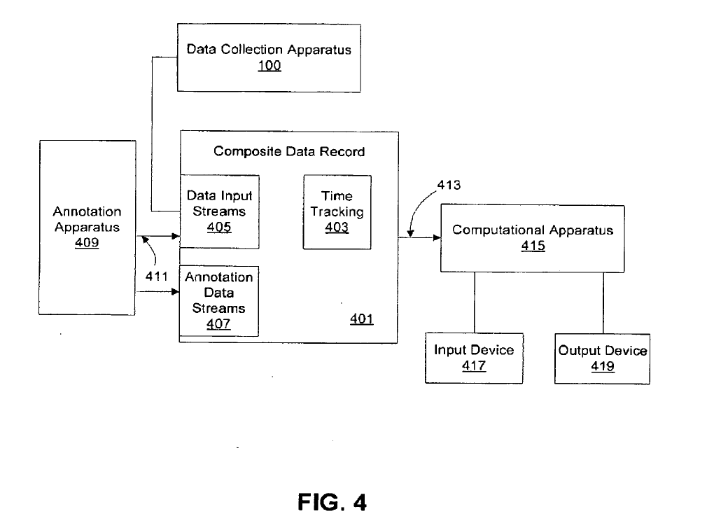

FIG. 4 represents a systematic block diagram of the data collection apparatus and data flow associated therewith. The collection apparatus 100 is simplified for in this embodiment description. The composite data record 401 includes time tracking 403 provided by the GPS unit 105 as needed for data correlation. The data record 401 also includes collected data input streams 405 and annotation data streams 407.

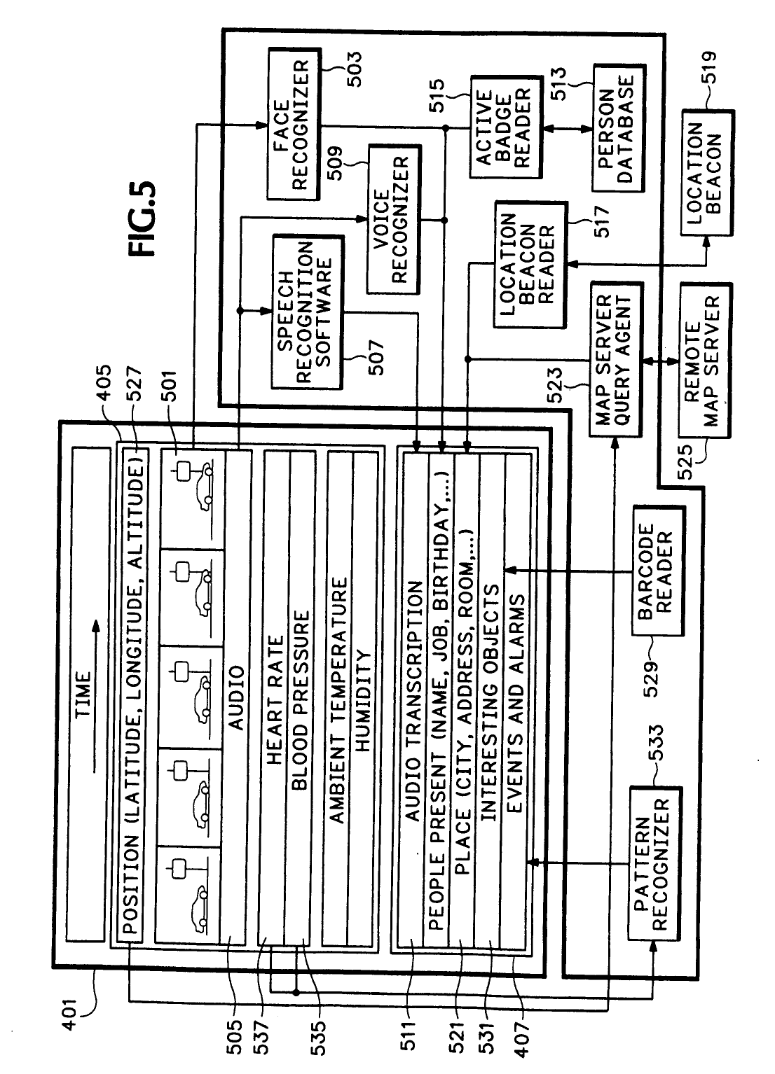

Collected data input streams 405 have individual data records that are represented by the labeled boxes shown as coupled to the collection apparatus 100 by arrows. In this embodiment annotation apparatus 409 are shown as a separate unit from the collection apparatus 100. Annotation data streams 407 have individual data records that are represented by the labeled boxes coupled to the annotation apparatus 409 by a single arrow. Such streams typically contain information about people, places, object, and events that are considered to be related to the immediate environment at particular points in time. They may also contain notes or other comments the user makes that are believed to be relevant to the immediate environment and may comprise a “reduction” of data input streams, e.g., the transformation of an audio stream into a textual transcript. The collected data input streams data records 405 are annotated, if so desired, by routing through the annotation apparatus 409, represented by arrow 411, thus forming respectively associated annotation data streams 407 having individual records related to the input streams. By this illustration, it is specifically intended that in addition to subunits of the apparatus 200 such as the microphone 215 of FIG. 2, that known manner manual input devices, such as computer keyboards or keypads, electronic styluses, barcode readers, optical character readers, or the like, can be adapted for use as such annotation mechanisms 409. Moreover, and referring briefly also to FIG. 5, automated annotation mechanisms such as image recognition, voice-print recognition, identity beacon transmissions, digital data bases (e.g., data transcript data streams, and the like) can be adapted for use as such annotation mechanisms 409.

Output comprising the collected data input streams 405 and any related annotation data records attached thereto in the annotation data streams 407 are routed (arrow 413) from memory (e.g., FIG. 1, memory unit 102) to an adapted, known manner, computational apparatus 415, (e.g., a personal computer, not shown), forming a composite data base for selective data processing. The computational apparatus 415 is used in conjunction with a known manner input device 417 using known manner programming processes for specifying queries into the record data base. The computational apparatus 415 is used in conjunction with a known manner output device 419 for displaying results of such queries.

Looking again to FIG. 5, an illustration of automated collected data annotation for the composite data record 401 is provided. As an example of an operational implementation, the collected data video data record 501 can be routed (data routing is again illustrated as in FIG. 4 by connecting arrows for all individual data records, e.g., video data record 501) to a program associated with facial feature recognition 503. Collected data audio data record 505 can be routed to a program associated with speech recognition 507 and specific voice recognition 509. A speech recognition 507 annotated audio data records 501 then forms an audio transcription 511 component of the annotation data streams 407.

Being obviously related, voice recognition and facial feature recognition 503 annotated data can be combined. Moreover, such video data 501 and face recognition data 503 can be combined with a person database data 513 and/or data from a device such as an active badge reader 515 associated with a particular person in the database 513. Note that video data record 501 so annotated 503, 509, 513, 515 forms an annotation stream 407, a “people present” data stream during an active recording session. Again, it should be recognized that manual annotation as described with FIGS. 2, 3 and 4 can at any time during the session to augment such automated annotations.

In the same manner, other automated annotation devices can be employed with captured data in the composite data record 401. As examples:
(1) a location beacon reader 517 associated with a location beacon 519 can be used for “place” annotation data record 521;
(2) a map server query agent 523 associated with a remoter map server 525 and the GPS individual data record 527 can be used for the “place” annotation data record 521;
(3) a barcode reader program 529 associated with appropriate known manner hardware (not shown) of the system apparatus 200, FIG. 2, can provide an appropriate “interesting objects” annotation data record 531 (note that interesting objects can also be associated with the video data record 501); and
(4) a pattern recognition program 533 can be associated with the biometric individual data records, e.g., “blood pressure 535” and “heart rate 537” data. Other automated annotation mechanisms can be adapted based upon the specific implementation of the invention.

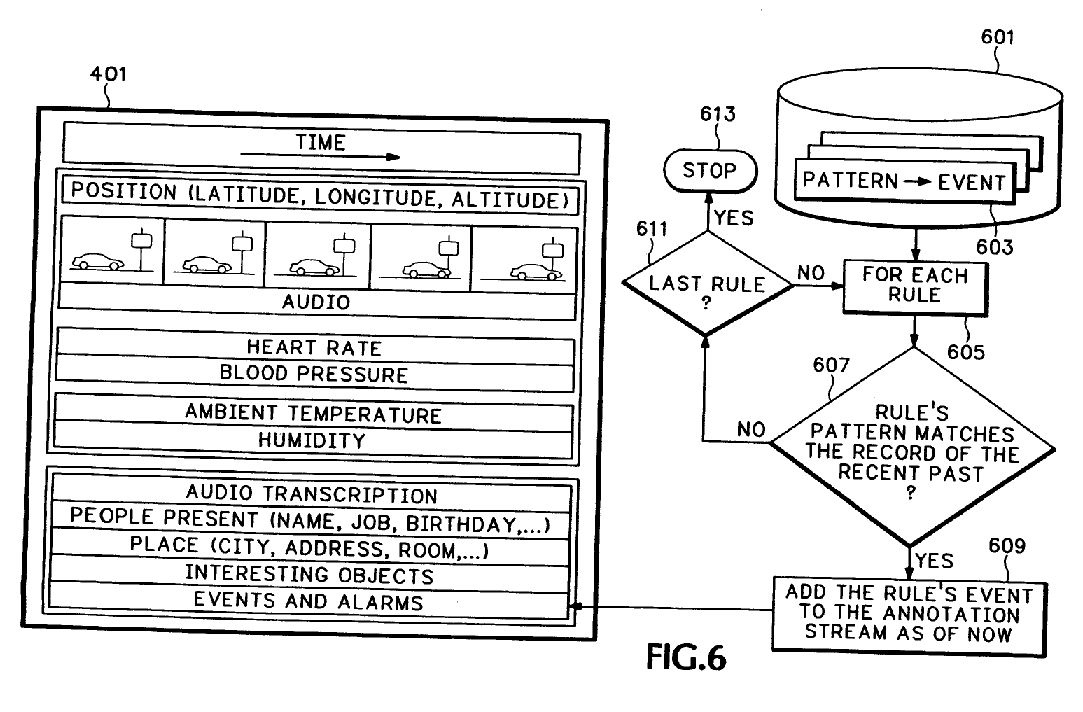

Pattern matching operations are illustrated by FIG. 6. Stored in memory 601 (or e.g., FIG. 1, 102) associated with the system can be a database of event patterns 603 or other indicia related to pattern matching. For example, there may be rules established for identifying patterns of related events, sounds, current medical conditions, or the like of the user, from the past which relate to current conditions as being recorded. A search for each relevant rule 605 a comparison test 607 can be established and run to look for matches between current data streams of particular interest and the database of event patterns 603. If a match is found, operation step 607, YES-path, the rule's event is added to the annotation stream as of the current time of annotation, operation step 609. If not, step 607, NO-path, then the operation can loop through each relevant rule, step 611, NO-path 605, until finished, step 613.

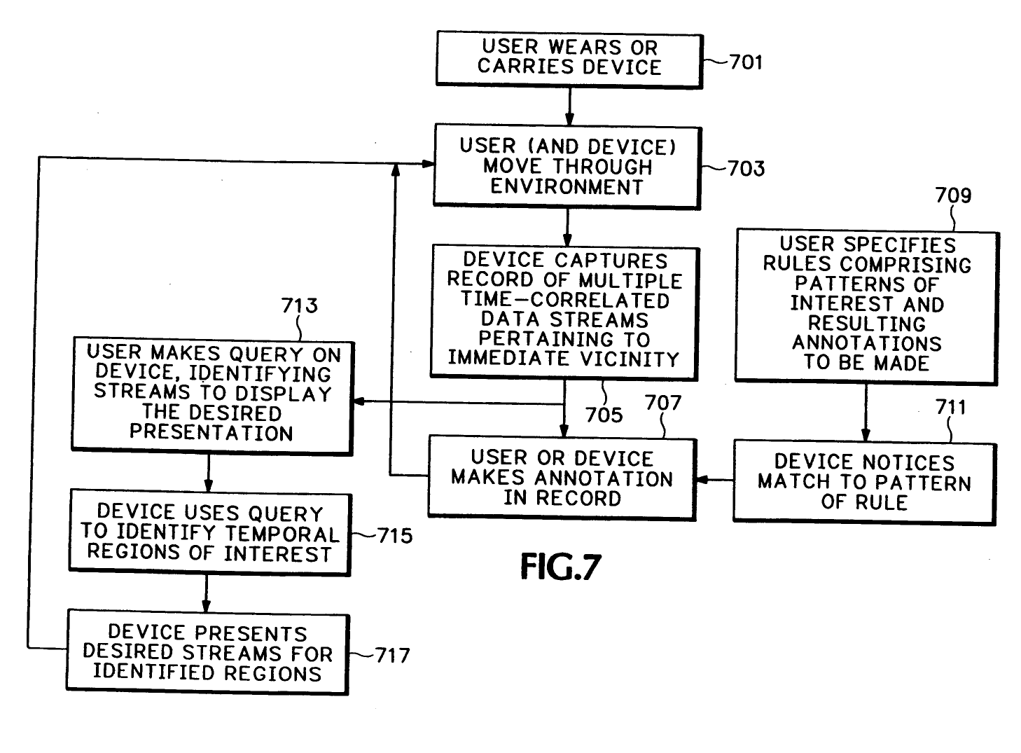

FIG. 7 is a flow chart for system operations which include event pattern input. The user wears the apparatus 200 as shown in FIG. 2, or carries a similar device or set of devices such as in a backpack or briefcase implementation, step 701, moving through a local environment, step 703, and capturing a record of multiple time-correlated, collected data input streams 405, step 705. Along the way, the annotation data streams are provided into the record 401, step 707. Off-line or in real time, depending upon the implementation and sophistication of the programming, the user has specified or specifies rules for patterns of interest correlated to annotations to be made, step 709. Whenever a match is noted, an automated annotation, as shown in FIG. 6 is added into the current record 401, step 711.

In the preferred embodiment, at anytime during data capture 705, the user can make a query, identifying which current input data streams to display and a desired mode of presentation (e.g., video playback, audio, hard copy printout, or the like), step 713. Temporal regions of interest in the stored data related to the query are identified, step 715, and displayed, step 717. The process continues as long as the recording session remains active.

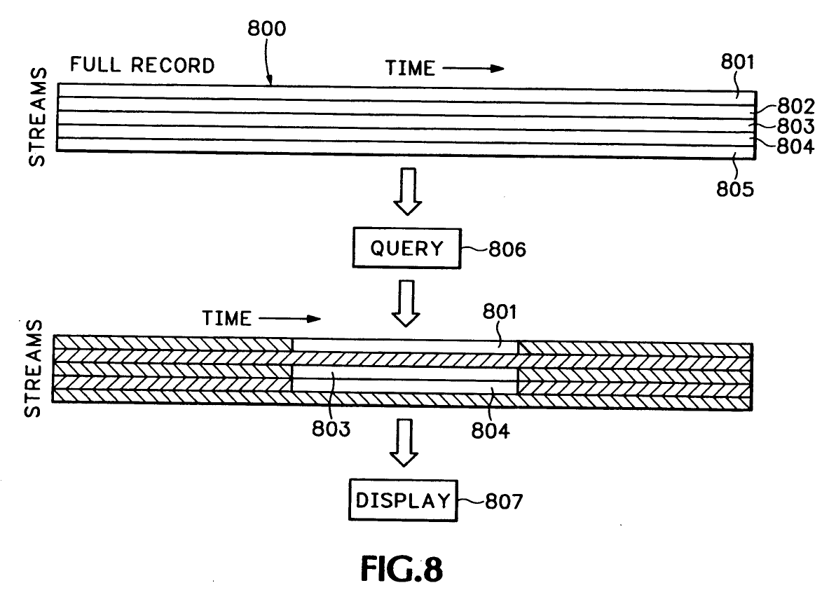

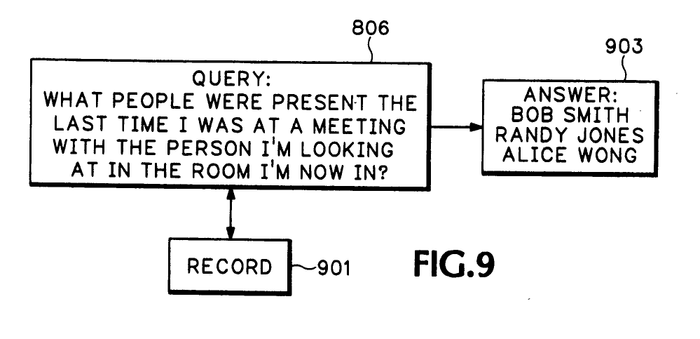

FIG. 8 is a graphical illustration of a response giving a list of attributes, where three data streams 801, 803, 804 of a full currently streaming record 800 relate to the current query 806. The extracted temporally related region data is displayed 807 in the specified mode of presentation. Looking now also to FIG. 9, there is provided a block diagram of an exemplary query 806 into memory using pattern matching (e.g, recognizing a place from current video data 405) and searching stored records 901 for an immediately previous presence of the user in the same place and fitting rules associated therewith. The response 903 to the specific query is displayed as specified.

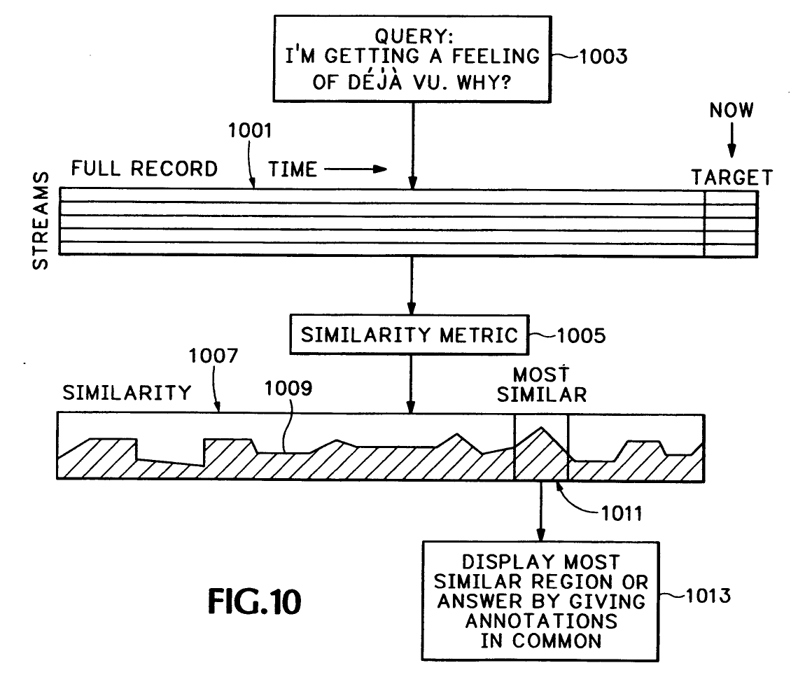

In effect, the present system allows for a recall of prior experiences which may be relevant to a current experience, e.g., a deja vu event. In FIG. 10, use of the system by deja vu query is illustrated. In the current full record 1001, the region label “Now→Target” represents a temporal record in the collected data input streams (see FIGS. 4 through 6), perhaps of only a few seconds, when the user experiences deja vu. The user issues a deja vu query 1003. The pattern matching rules in this aspect of the invention are based on “similarity metric(s)” 1005. The “Similarity” graph 1007 depicts a search backward in time through the stored database using the similarity metric 1005 to create a similarity profile, represented by the shaded region 1009. From the profile 1009, a “Most Similar” temporal period 1011 is recognized. A display 1013 is generated, providing the user with all of the records for that period 1001 or with annotation data streams related to that period, or both.

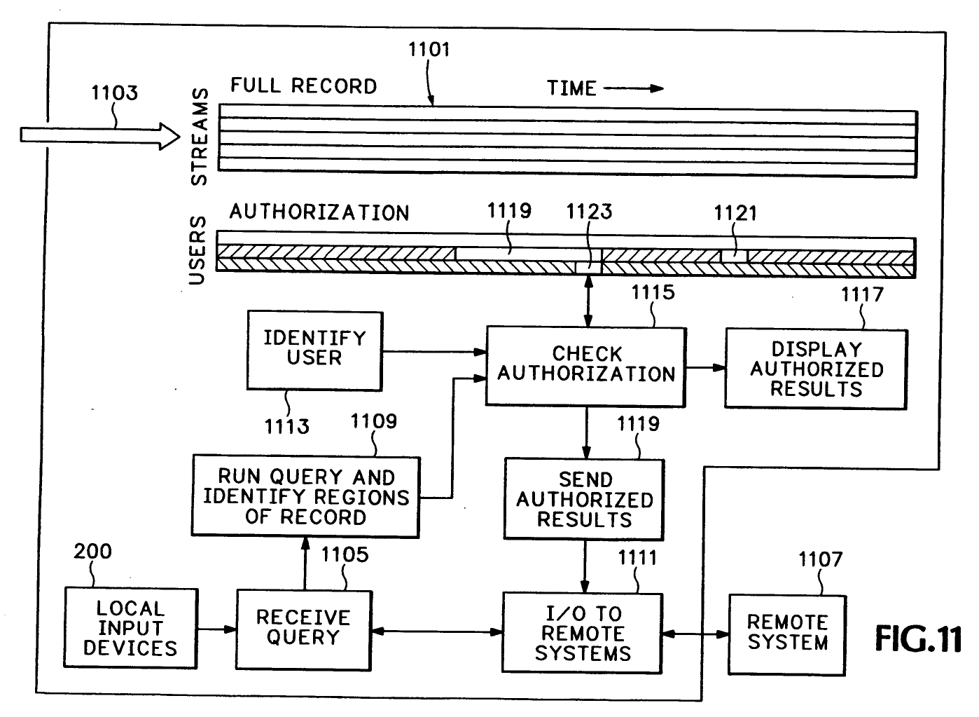

As the system is making a physical record and virtual record of events that may be highly personal, related to business confidentiality requirements, or the like, in the preferred embodiment, the invention also provides for security measures related to system use and record retrieval. FIG. 11 illustrates the security aspects of the present invention. Again, a current record 1101 comprises a set of time-based, collected data input data streams 1103 from the local input apparatus 200 and associated query devices and mechanisms 1105 for running the query 1109 (analogous e.g, to FIGS. 8-10, 806, 1003). Note that the query may come from a remote system 1107 via an appropriate input-output port 1111 (analogous e.g., to FIG. 1, 111). A known manner user identification module 1113 is provided. For example, the user may be required to enter a personal identification number (“PIN”) via the control panel 204, FIG. 2, before the system can be activated. An authorization check 1115 is provided to allow use and access. In the preferred embodiment the system is usable by anyone having an associated identification and authorization code. Thus, the “Authorization” bar chart 1117 is illustrative of a three user system. In this example, one user, viz. the current user, has been authorized for full access, shown as a clear bar; one user has been authorized for access to two temporal regions of data 1119, 1121; and one user has been authorized for access to a small temporal region of data 1123. The second and third users may be currently on-line via remote systems 1107. Authorized results are displayed 1117 and transmitted 1119 across the I/O port 1111 in accordance with levels of authorization in effect. For example, assume the current user is in a business meeting, making the full record (i.e., clear bar authorization). One remote user might be the user's supervisor who has a need to know certain events 1119, 1121. The other remote user might be a customer who only needs to know a certain limited presentation or result of the meeting 1123.

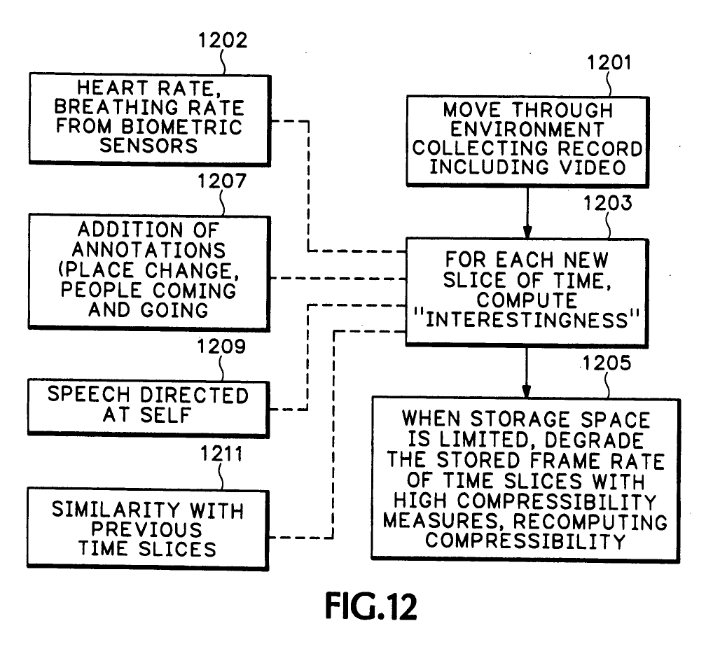

As mentioned briefly with respect to FIG. 3, step 323, editing or data compression can be provided. FIG. 12 is a flow chart illustrative of one embodiment of a data compression module where provided rules with respect to a computation of level of interest is used. Again, as in FIG. 3, step 311, FIG. 7, step 703, the user moves through his or her local environment collecting data, focusing now on the video data input data stream (see e.g., FIG. 5, input data stream 501), step 1201. At the same time, the biometric unit 106 (FIG. 1) and related the biometric sensor 217 (FIG. 2) provides associated input data stream 1202, annotations are made 1207, speech directed at the user and user subvocalizations are recorded 1209, similarity metrics are employed 1211 (see FIG. 10), and the like input data streams form a composite record (401, FIGS. 4-6). “Interestingness” is computed for each specified slice of time of the full record, step 1203. Note that the “rules” can be automated because input data such as heart rate, breathing rate, similarity, can be recognized. Depending on available storage capacity in memory 102 (FIG. 1), the video frame rate can be adjusted, e.g., degrading the stored frame rate of time slices with high compressibility measures, viz., least interesting, and recomputing current data compressibility automatically according to the specified rules (e.g., higher heart rate, fast breathing=“very interesting”), step 1205. With speech recognition, the system can implement commands, such as “Interesting” and “Not Interesting,” whereby the specified slice of past time data can be edited such as with deletion or compression to a correlated time period.

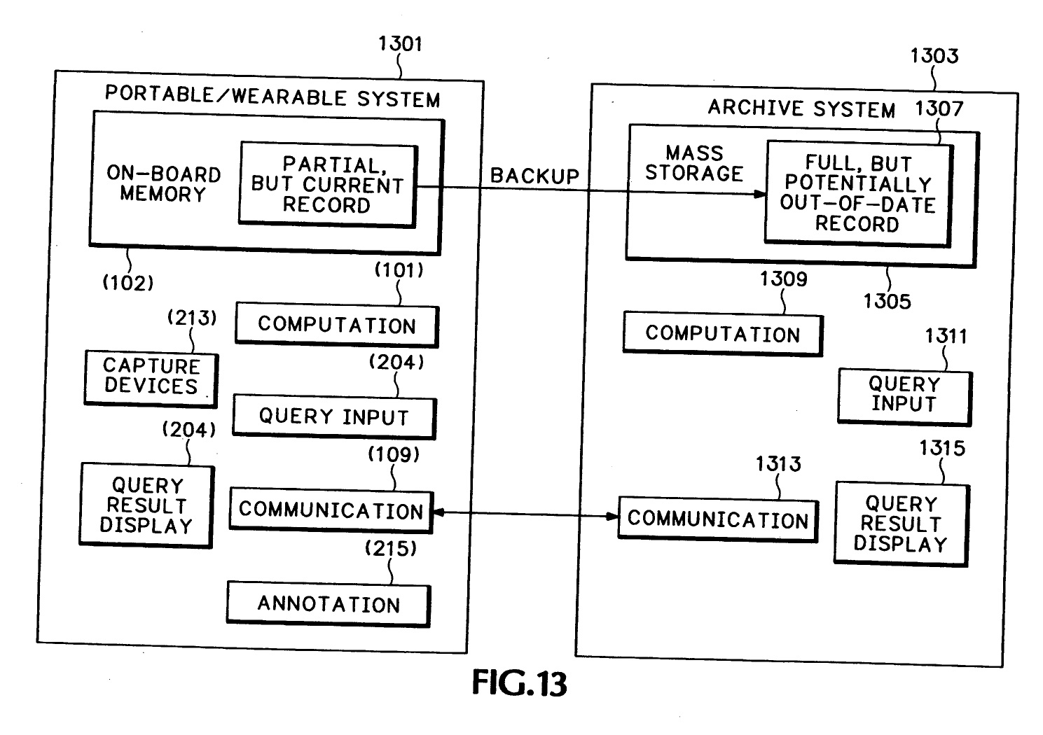

FIG. 13 is a block diagram illustrating use of a portable/wearable apparatus system embodiment 1301 in conjunction with an archive system 1303; exemplary units now shown in labeled box form are exemplified by representative element numbers from other FIGURES in parenthesis. Subsystems of the apparatus system 1301 and archive system 1303 are electrically/optically interconnected (including wireless) in accordance with the current state of the art as needed for data retrieval, recording and transmission (see e.g., FIG. 1). The archive system 1302 includes a known manner mass data storage unit 1305 where archival data 1307 is stored. A computation unit 1309 is provided for running programs and hardware associated with data storage and deletion, retrieval 1311 from mass storage 1305, transmission 1313, and display 1315 of archival data 1307.

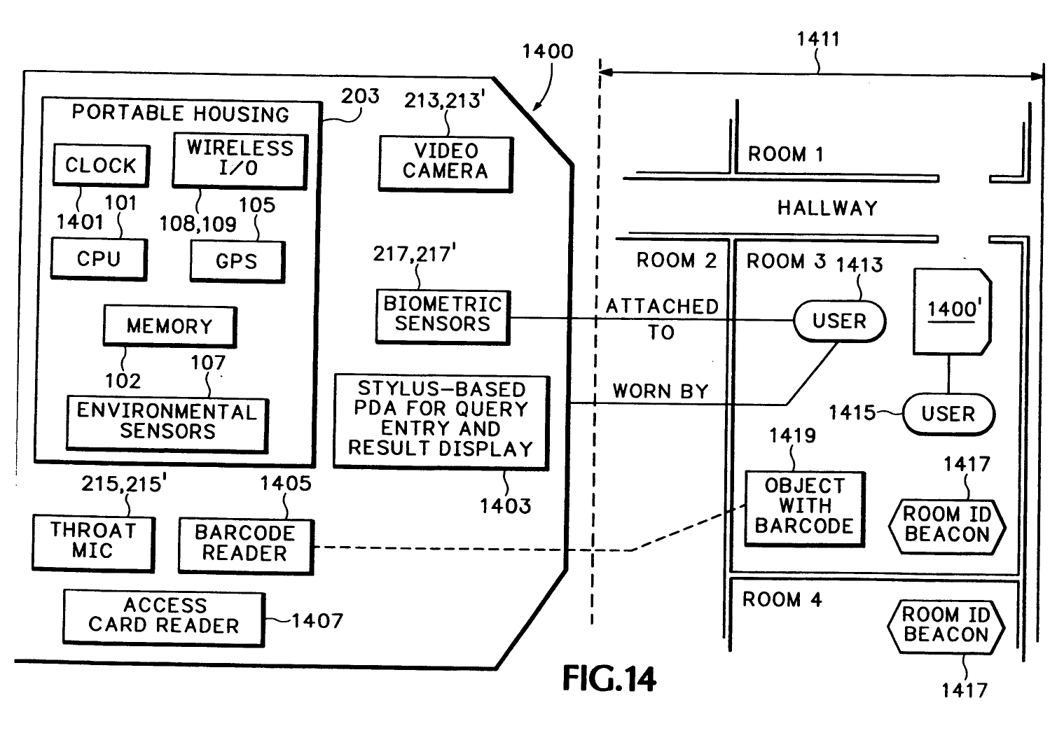

FIG. 14 is a schematic diagram illustrating the operation of the present invention to capture a substantially comprehensive record of an immediate environment of the user. In this alternative embodiment of a composite data collection system 1400, while it may be in one miniaturized package worn or carried by the user or in such form as briefcase implementation, for convenience of explanation, the drawing uses component references from FIGS. 1 and 2 to represent subunits of the system. In this embodiment, the case, or “portable housing,” 203 including a separate clock 1401 for this embodiment, supplementing GPS 105 time; e.g., one or the other can be at local time while the other maintains an absolute time, such as Greenwich Mean Time. Also included in this system 1400 embodiment is a personal digital assistant (PDA) 1403 which is adapted for use in controls, query entry, and display. A barcode reader 1405 and card reader (e.g., magnetic stripe, optical, or the like) 1407 are also included. In the representative environment 1411, having four rooms and a hallway, the users 1413, 1415 are free to transit from place-to-place, using their respective system 1400, 1401′ to create respective composite data records from each one's perspective. Adapted to the system 1400, places within the environment 1411 can be provided with identification beacons, or the like, 1417. Objects 1419 of use within the rooms may be provided barcodes in order to adapt to the system.

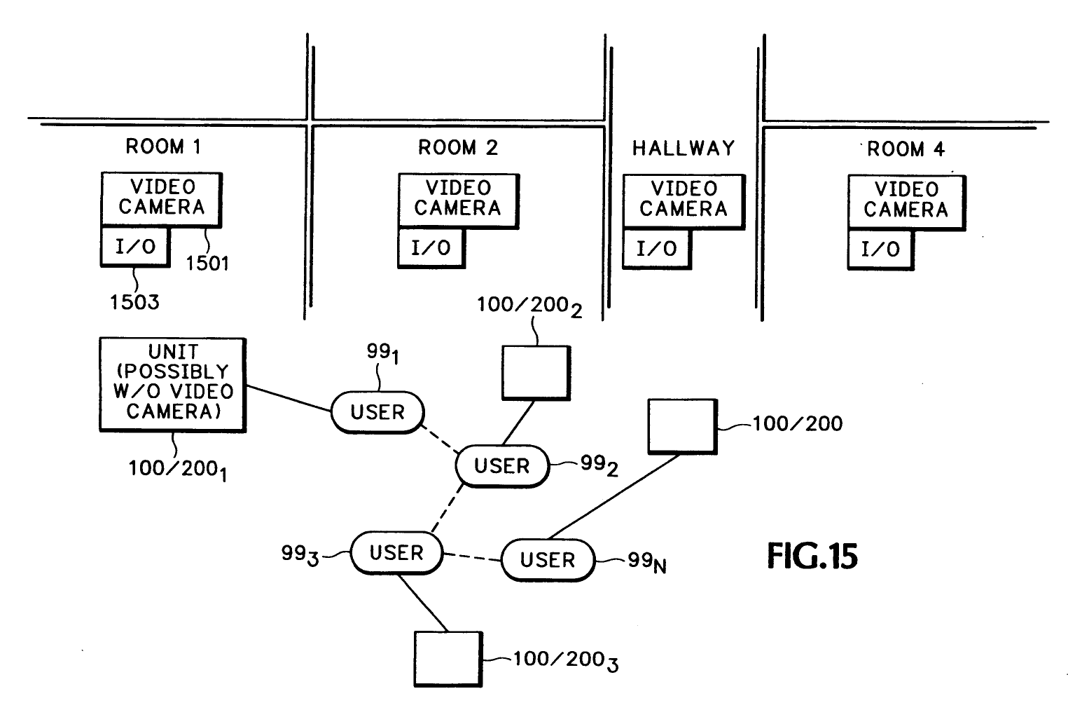

FIG. 15 is illustrative of another embodiment of the present invention. In addition to individual collection system apparatus 100/200_{1 . . . N} associated with each user 99₁, 99₂, 99₃ . . . 99_{N}, input data streams can be provided remotely from fixed environmentally mounted data capture devices, such as exemplary video cameras 1501 having wireless transmission I/O subunits 1503. In accordance with authorization protocols as described with respect to FIG. 11, the users 99_{1 . . . N} might share collected data input data streams, for example, using electronic mail or other telecommunications devices associated with each.

The present invention provides a complete system for maintaining autobiographical or other surveillance-type data in a passive, yet comprehensive and secure manner. Data collected as input is subject to pattern matching and data mining programs.

The foregoing description of the preferred embodiment of the present invention has been presented for purposes of illustration and description. It is not intended to be exhaustive or to limit the invention to the precise form or to exemplary embodiments disclosed. Obviously, many modifications and variations will be apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . ” and no process step herein is to be construed under those provisions unless the step or steps are expressly recited using the phrase “comprising the step(s) of . . . .”

What is claimed is:

1. A system for accessing a substantially comprehensive record of an immediate environment of a user, comprising:
a substantially continuous record of information from a plurality of time-correlated input data streams;
means for specifying a query into the record; and
means for displaying a result of a query made using said means for specifying a query.

2. The system of claim 1 comprising:
the input data streams are taken from a set consisting of video data, audio data, data representative of the user's location and changes thereof, data representative of measurements of the user's physical state, and data representative of local ambient environment conditions of said immediate environment, and current and reference standard time.

3. The system of claim 1, further comprising:
means for collecting said record.

4. The system of claim 1 comprising:
the plurality of time-correlated input data streams includes at least one annotation data stream associated with at least one of said time-correlated input streams.

5. The system of claim 4 comprising:
the annotation data stream is from a set consisting of transcription of speech, information representative of people present on camera or speaking, information representative of location, information representative of user activities, information representative of aspects of video and audio input not directly input by said collecting means, information representative of the user's biometric or emotional states, and information representative of other events of said immediate environment not directly input by said collecting means.

6. The system of claim 4, further comprising:
means for providing said annotation data stream.

7. The system of claim 6 comprising:
the means for providing said annotation data stream is an input device by which said user generates annotations.

8. The system of claim 6 comprising:
the means for providing said annotation data stream is an automatic input device wherein annotation is implemented based on other data in the record.

9. The system of claim 8 wherein the means of providing said annotation data stream is triggered by detection that data in at least one of said time-correlated input data streams matches a predetermined pattern.

10. The system of claim 9, further comprising:
means for specifying at least one said predetermined pattern and an annotation representative thereof to insert in the record when the predetermined pattern is detected.

11. The system of claim 6 comprising:
the means for providing said annotation data stream includes means for using a remote data source.

12. The system of claim 1 comprising:
the means for displaying a result includes means for presenting a time-bounded segment of at least one of said time-correlated input streams from the record.

13. The system of claim 12 comprising:
said means for presenting provides a presentation of a time-bounded segment of a plurality of said streams from the record wherein the presentations are overlaid.

14. The system of claim 13, wherein one of said streams is a video data stream, comprising:
overlaying the video data stream with subtitles visible during video playback.

15. The system of claim 13, wherein one of said streams is a video data stream, comprising:
overlaying the video data stream by inserting word balloons visible during video playback.

16. The system of claim 4 comprising:
the means for displaying a result of a query includes means for presenting a set of annotations.

17. The system of claim 4 comprising:
the means for specifying a query includes means for identifying a target time-bounded segment of the record.

18. The system of claim 17 comprising:
the means for identifying includes means for finding a segment based on the attributes contained in the record during the segment and means for specifying a set of attributes of interest for testing whether the segment matches.

19. The system of claim 18, further comprising:
said set of attributes includes a similarity metric, wherein the means for identifying identifies the target time-bounded segment based on strength of similarity under the similarity metric to a second segment; and
means of identifying the second segment.

20. The system of claim 19 wherein the second segment is an interval of time immediately prior to the present.

21. The system of claim 1, further comprising:
means for identifying a plurality of users and for proving system use authorization for the users.

22. The system of claim 21 comprising:
the means for displaying requires proof of authorization via said means for identifying a plurality of users and for proving system use authorization before displaying data from the record.

23. The system of claim 21, further comprising:
means for identifying a subset of the record and for providing authorization for viewing the subset to another person or system.

24. The system of claim 1, further comprising:
means of extracting a subset of the record and transmitting an extracted said subset to a secondary system or a device compatible with the system.

25. The system of claim 1, further comprising:
means for compressing the record by deleting information.

26. The system of claim 25 comprising:
the means for compressing the record includes a level-of-user-interest metric, deleting information based upon identifying uninteresting information in the record in accordance with said level-of-user-interest metric.

27. The system of claim 26 wherein the interestingness metric consists of one or more criteria including changes in annotation, biometrically-determined interest or excitement level, frame-to-frame video change, overall similarity between a selected segment of said time-correlated input data streams and segments which precede said selected segment.

28. The system of claim 26 wherein the deleting information is based upon reducing the frame rate of a video data stream of said time-correlated input data streams.

29. The system of claim 26 wherein the plurality of time-correlated input data streams includes at least one annotation data stream associated with at least one specified one of said time-correlated input streams and wherein the deleting of information is based upon discarding input stream data and retaining annotations of said at least one annotation data stream.

30. The system of claim 26, wherein the record comprises a portable part and an archival part, the system further comprising:
means for transmitting a subset of the record wherein deleting information is based upon transmitting information to be deleted from the portable part to the archival part.

31.-81. (canceled)
